(19) United States
(12) Patent Application Publication
(10) Pub. No.: US 2005/0177457 A1
(43) Pub. Date: Aug. 11, 2005

(54) Computerized method for the solicitation and sales of transactions

(76) Inventors: Steven Peter Sheltz, Louisville, KY (US); Michael Healey, Louisville, KY (US); Rebecca Leann Carr, Louisville, KY (US); Kristi Harberts Fiscus, Louisville, KY (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 11/063,317

(22) Filed: Feb. 22, 2005

Related U.S. Application Data
(63) Continuation of application No. 09/996,637, filed on Nov. 29, 2001.

(51) Int. Cl. G06F 17/60

(52) U.S. Cl. 705/26

(57) ABSTRACT

A computerized method for managing electronic data configured to enable the generation of paper and electronic solicits for effectuating consumer service transactions between a consumer and a service center. The method allows for selecting populations for receiving paper and/or electronic solicits for purchase of extended warranties generated as a function of consumer and product related data. The method also allows for the consumer and product data to be copied to Web based solicit response tables and for the scheduling and generation of electronic solicits via email delivery. Each email also contains a unique and personalized link that permits the consumer to link directly to a Web page menu that includes data indicative of warranty services that may be purchased by that consumer. Warranty service data of the paper solicit, the electronic solicit and the Web based solicit are synchronized so the consumer will receive the same data in each medium. Feedback is provided to the service center to suppress further solicits once the consumer has made a purchase.

This application is a Continuation, and claims filing date benefit, of U.S. application Ser. No. 09/996,637 filed Nov. 29, 2001, which is incorporated herein by reference in its entirety.

### BACKGROUND OF THE INVENTION

The invention pertains generally to computerized methods of managing electronic data for effecting a transaction over a telecommunications medium and more particularly to the management of electronic data configured to enable the generation and delivery of electronic and paper solicitations, tracking their status and enabling consumers to close the purchase of services over a telecommunications medium.

Manufacturers of consumer products have a strong interest in establishing and maintaining consumer loyalty. This is not easily attained in a competitive marketplace. Consumer loyalty is cultivated not only through the manufacture of high quality products that meet or exceed consumer expectations, but also through the provision of consumer friendly support services after purchases have been made. For instance, the majority, if not all, of consumer products, particularly durable goods such as home appliances, are sold with express and implied warranties, which are included in the retail purchase price. The scope of such warranties and the ability of the manufacturer to comply with its warranty obligations is an important step in cultivating a long-term relationship with a consumer. However, while express and implied warranties provide a certain peace of mind to the consumer, they have a finite life, typically one year. Consequently, as part of a manufacturer's ongoing efforts to develop and retain consumer loyalty, extended warranties are offered to consumers for continued assurance that their products will function properly over time after express or implied warranties have expired.

Traditionally, manufacturers of consumer products would offer extended warranties at the point of sale or in a paper solicitation mailed to the consumer shortly after a purchase has been made. Consumers are sometimes reluctant to purchase extended warranties at the point of sale. This is frequently because they are not sure whether extended warranties are cost effective and, in the case of a major appliance, the consumer has just made a large capital expenditure and may not want to make an additional commitment of their capital resources to purchase an extended warranty at the point of sale. Thus, it may be advantageous to solicit the purchase of extended warranties at some point in time after the purchase has been made.

Typically at the retail point of sale personalized consumer information is collected and entered into the retailer's database for future use by the retailer for promotional purposes or the mailing of other solicitations. This information may be passed along from the retailer to the manufacturer. Also, consumers are frequently required to fill out warranty registration cards that include personalized consumer information in order for their express warranties to become effective. Thus, if point of sale extended warranties are not purchased, the manufacturer usually acquires the necessary consumer information for making a follow-up solicitation. Such solicitations have traditionally been made by mailing paper solicitations to the consumer with an offer of an extended warranty. This offer is typically tied to a single product so if a consumer purchased more than one major appliance, for example, paper solicitations would be generated for each appliance.

It is well recognized that consumers receive a rather large volume of paper solicitations in the mail from various sources, which can present a daunting information and time management challenge to the consumer, especially those working full time and with families. In the face of this challenge, it is not uncommon for a consumer to hastily sort through paper solicitations and throw them away without fully evaluating each solicitation or appreciating the consequences of their decision to throw them away. Plus, paper solicitations must be filled out by hand then mailed or delivered to the appropriate destination, which can operate as a deterrent to some consumers from making the purchase. Consumers may throw away paper solicitations for extended warranties for these and other reasons, such as the consumer wanting to defer another purchasing decision for as long as possible. If manufacturers do not make an extended warranty sale, this paper solicitation cycle may go on for some time.

In view of the above, it would be desirable to provide a computerized method that enables a manufacturer to manage personalized consumer information pertaining to the purchase of goods in order to generate solicitations for the purchase of extended warranties. It would be further desirable to enable the manufacturer to generate not only paper solicitations but also electronic solicitations where the electronic solicitations would enable the consumer to purchase an extended warranty over a telecommunications medium. Such method provides the manufacturer with an efficient means for tracking the consumer's purchasing decision and affords the consumer the ability to conduct such a transaction electronically, which can improve the consumer's efficiency in time and information management. It may also reduce the manufacturer's cost compared to the resources expended to mail paper solicitations and manage their receipt.

### BRIEF SUMMARY OF THE INVENTION

In general, the present invention fulfills the foregoing needs by providing in one aspect thereof, a computerized method for managing electronic data configured to enable a manufacturer to offer extended warranties to consumers through paper and electronic solicits and to enable the consumer to purchase the warranty services over a telecommunications medium. The term solicit refers to an offer made to a consumer or other third party such as a commercial enterprise by way of any medium. The medium may be paper, electronic, fiber optic or other mediums over which data may be conveyed.

The method allows for selecting populations from preexisting databases to receive paper or electronic solicits based on at least consumer preferences. Personalized consumer information associated with these populations is processed in a warranty-pricing program to generate personalized pricing to be included in offers made to the associated consumer in a solicit. The method also sorts paper from electronic solicits and sends them to predetermined destination files. An electronic database file is created for each paper and electronic solicit with the paper solicit files being transmitted electronically to a center for generating paper solicits that may be sent to consumers via standard or bulk mail delivery. The paper solicit database files are also sent to a fulfillment database associated with a live call taking application to receive responses from consumers. The electronic solicit database files are also electronically transmitted to the fulfillment database.

The present invention further fulfills the foregoing needs by providing in another aspect thereof a method for managing data for enabling the generation of electronic solicits to be transmitted to consumers via email. The method allows for copying the fulfillment database to a set of Web based solicit response tables. The method also allows for the solicits to be prioritized before being sent by email based on preferences set by a service center. An email is then generated and sent to a consumer's associated email address. A unique and personalized link is provided in the body of the email whereby the consumer may click on the link to connect to a Web application containing that consumer's personalized solicit. The personalized solicit may be an offer to purchase a services contract and may contain a series of Web pages having pricing and options tailored to that specific consumer's needs. The consumer may then purchase the extended warranty services contract through the interactive Web application. The data contained in the paper solicit and the Web based solicit generated for a specific consumer are synchronized so that each one contains the same information. A consumer may still purchase the extended warranty services contract through traditional means such as mailing or telephoning the service center, if desired.

In another aspect of the present invention a method is provided for managing electronic data to track the behavioral patterns of consumers receiving an electronic solicit. In this respect, feedback is automatically provided to the service center in the event a consumer opens an email solicit. Similarly, if the consumer clicks on the unique and personalized link the service center will receive feedback. If the extended warranty is purchased, feedback is provided to suppress further solicits from being delivered to that purchasing consumer.

### DESCRIPTION OF THE DRAWINGS

FIG. 1 is a schematic of an exemplary computerized system that may be used for executing a method for managing electronic data that enables the offering and purchasing of extended warranties to consumers through paper and/or electronic solicits;

FIG. 2A is a flow chart of in accordance with one exemplary embodiment of the present invention;

FIG. 2B is the flow chart of FIG. 2A continued;

FIG. 3 represents an exemplary web page form that the consumer may use for selecting products to be covered by the warranty;

FIG. 4 represents an exemplary web page form that the consumer may use for selecting the number of years of extended warranty coverage;

FIG. 5 represents an exemplary web page form that the consumer may use for selecting the payment option for purchasing the extended warranty coverage; and

FIG. 6 represents an exemplary web page form summarizes the consumer's extended warranty coverage prior to making the purchase.

### DETAILED DESCRIPTION OF THE INVENTION

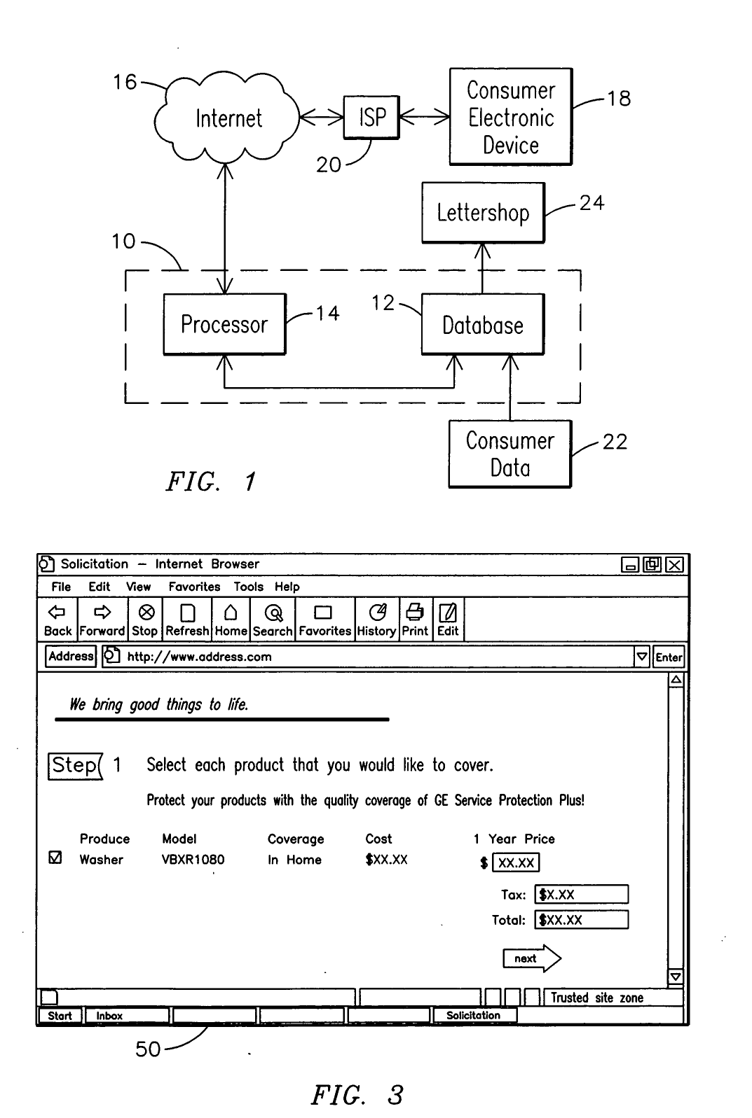

FIG. 1 is a schematic representation of an exemplary computerized system that may be used for generating, delivering and tracking solicits for warranty services between a consumer and a service center, such as may be operated and managed by the assignee of the present invention. By way of example, the service center may comprise a computer server system 10 that includes a database 12 connected to a computer processor 14 that manages electronic data configured to enable the generation of paper and electronic solicits. The database 12 and computer processor 14 may be interoperably connected by a local or wide area network, for example. The electronic data is managed to execute the purchase of warranty service contracts over a suitable telecommunications medium 16, such as the Internet or other Web-enabled mediums, for example. As will be readily understood by those skilled in the art, the computer processor 14 may include a single computer server or it may include a plurality of individual servers where each server performs a separate function. For example, one server may be configured as an email server, one as a Web page server and one as a database server or a single server that is properly configured may perform each of these functions.

The telecommunications medium 16 is connected with a telecommunications device 18 such as a computer loaded with any commercially available Web browser that may be used by a consumer, as more fully described below, for downloading Web pages generated by the server system 10 and transmitting data back to the server system 10. The telecommunications device 18 may also be loaded with any commercially available software application for sending and receiving electronic mail (“email”). Telecommunications device 18 may be other conventional devices suitably configured for data reception and transmission such as personal digital assistants or wireless phones, for example. The telecommunications device 18 is connected via a service provider 20 with the telecommunications medium 16 for sending and receiving data transmissions including emails. The service provider 20 may be any entity that enables transaction services in commerce and in one aspect of the present invention is a commercial Internet service provider. It should be understood that the various data files of the present invention might be stored on database 12 or other appropriately configured data storage devices.

FIG. 1 also illustrates that a set of consumer data 22 may be entered into database 12, which may be accomplished by any conventional means such as a keyboard or voice activated commands, for example. Discrete records or data files may be created for each consumer within the set of consumer data 22. For example, discrete data files may be created for a particular consumer and contain all warranty offers for that consumer or multiple data files may be created, one for each discrete warranty offer to a particular consumer. A unique identifier, such as a 12-digit reference number, is created and assigned to each discrete data file so that data file may be accessed for future purposes. The data files may be stored on and managed from database 12 or other appropriate databases connected with the computer server system 10.

The consumer data 22 is collected by the service center after a consumer purchases a product. The consumer data 22 may be collected at the point of sale or through the consumer filling out and submitting warranty registration information pertaining to the purchased product. This information may be submitted via a paper card, electronically or by other available means. The consumer data 22 may include consumer-related data that is personal to a particular consumer such as the consumer's home address, telephone numbers, email address, etc. and whether the consumer prefers to receive future correspondence from the service center via regular mail, email or by other means. The consumer data 22 may also include product-related data that is specific to the product or products purchased by a consumer such as the brand, model number and serial number, etc. as well as other data desired by the service center pertaining to a specific transaction. The consumer data 22 and the database 12 may be managed by commercially available database software applications. FIG. 1 also illustrates a letter shop 24 that may be used for the preparation and mailing of paper solicits in one aspect of the present invention as more fully described herein below.

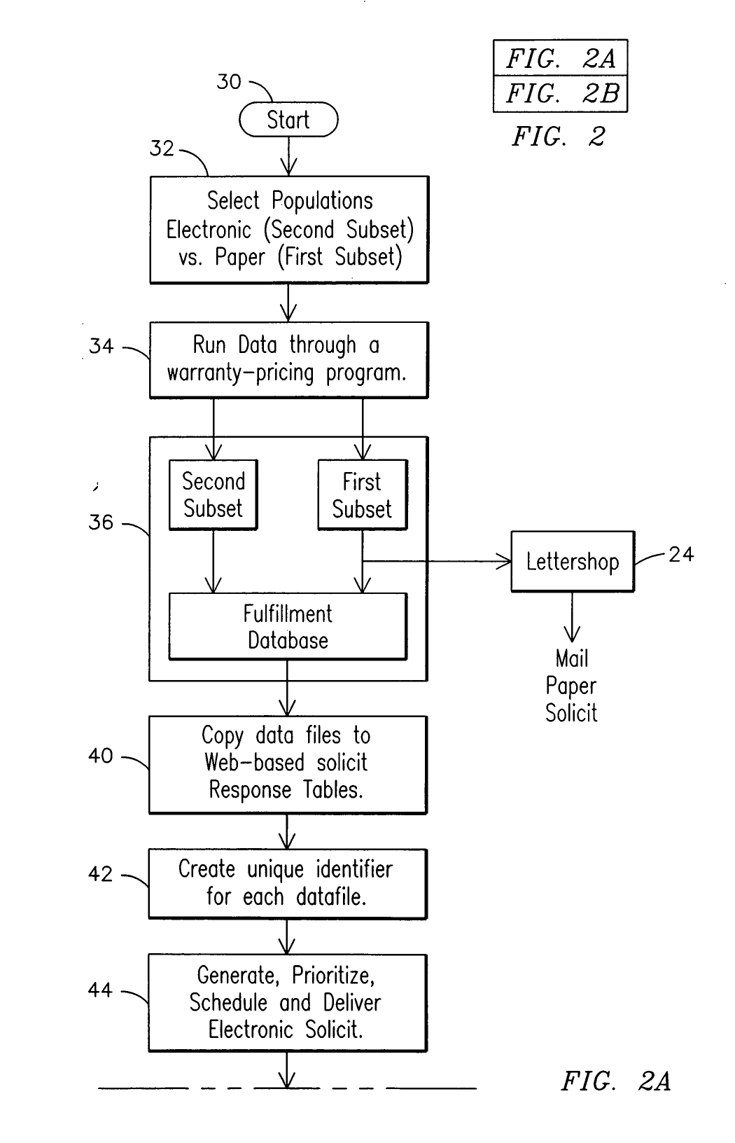

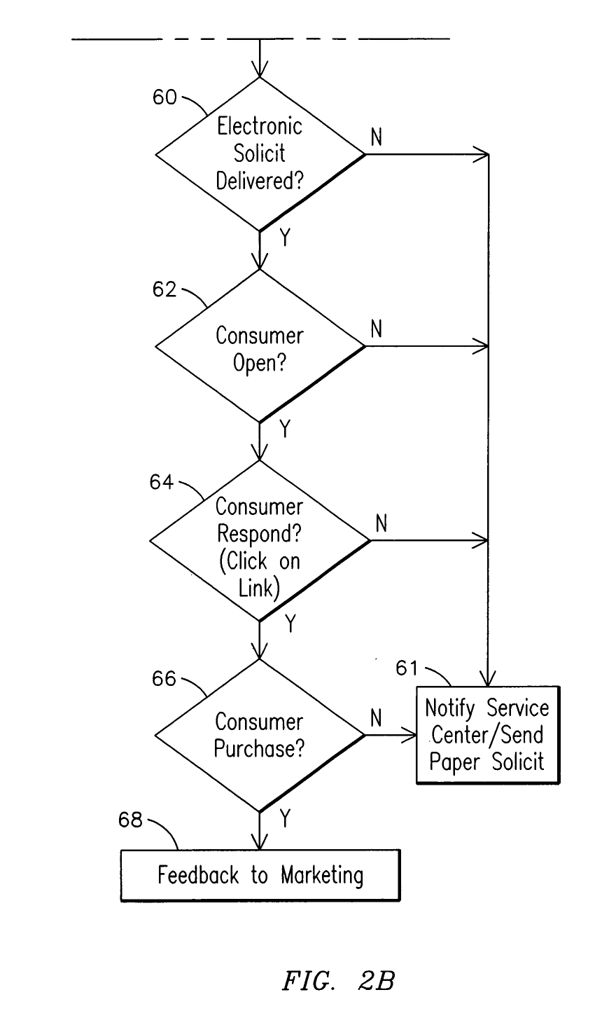

FIG. 2 is a flow chart illustrating exemplary steps of a computerized method in accordance with one aspect of the present invention. Subsequent to start step 30, step 32 allows for the selection of two populations, or subsets, of consumers from the set of consumer data 22. A first subset of consumers is selected that will first be contacted by the service center through a paper solicit. A second subset of consumers is selected that will first be contacted by the service center through an electronic solicit. In one aspect of the invention, the subsets are selected based on predetermined preferences set by the service center. The first subset may be selected based on a consumer's preference found in consumer data 22 for receiving correspondence from the service center via regular mail even though that consumer has submitted an email address as part of consumer data 22. The second subset will be selected based on the presence of a consumer's email address as part of consumer data 22 and that consumer's preference for receiving correspondence from the service center via email as indicated by that consumer and found in consumer data 22. If a consumer's email address is found in consumer data 22 but no preference is found for the method of receiving correspondence from the service center then that consumer will be selected for the second subset. Other preferences may be established by the service center as desired.

After selecting the two subsets of consumers in step 32, step 34 allows for certain information from the consumer data 22 associated with the first and second subsets to be run through a warranty-pricing program to determine an extended warranty offer for a specific purchase or purchases that will be offered to the associated consumer in a solicit. Each extended warranty offer becomes part of the associated consumer's respective data file. Step 34 also allows for the data included in the paper solicit and Web application to be synchronized so that product-related and consumer-related information specific to a transaction and the associated warranty offer are consistent across each media. In this manner, the consumer will receive the same warranty offer in each media delivered to the consumer. Also, one aspect of the invention allows for such data to be consistent between sequential service contracts for a specific consumer. Historical solicit data may be stored and maintained for each consumer in step 34 so that subsequent solicits may take into account a consumer's purchasing patterns of prior service contracts.

Step 36 allows for sorting the data files based on the first and second subsets selected in step 32 and transmitting them to predetermined destination files. As further shown in FIG. 2, step 36 also allows for transmitting the first and second subsets of data files to a destination file associated with a fulfillment database, which may be part of database 12 or a separate database. The fulfillment database is associated with a live call-taking function of the service center that processes consumer purchases of extended warranty services as well as batch programs to process purchase made through the mail. All extended warranty offers for the first and second subsets of data files are stored on at least the fulfillment database. The data files of the first subset are also transmitted to a destination file associated with a database of letter shop 24, which may also be part of database 12 or it may be a separate database. Step 40 allows for the data files of the first and second subsets to be copied to Web based solicit response tables, which may be stored on database 12 or another appropriately configured data storage device. A unique identifier, such as a 12-digit reference number, may be created at step 42 for each data file. Each unique identifier may be operably embedded with a unique and personalized link also associated with that data file to be delivered to the consumer associated with that data file. The unique and personalized link may be incorporated within an electronic solicit, such as being inserted in the body of an email, and delivered to that consumer's email address contained in consumer data 22. The unique identifier may be embedded within the link when an email is generated as part of step 44. If a consumer activates the link then that consumer's telecommunications device 18 will download a Web page for accessing a Web application for reviewing and executing the purchase of that consumer's extended warranty offer over the telecommunications medium 16. When the link is activated, the unique identifier is also activated to access that consumer's personalize warranty offer from the associated data file stored in the Web based solicit response tables.

After step 40 of copying the data files into Web based solicit response tables, step 44 allows for generating, prioritizing, scheduling and delivering electronic solicits. In one aspect of the invention, the electronic solicit, which may be included in the Web application, is delivered as an email transmitted over the telecommunications medium 16. Step 44 provides for the prioritization of email deliveries based on predetermined preferences. For example, segments of the target market for delivering extended warranty solicits may be selected based on the date of a consumer purchasing a product, whether a consumer's existing warranty contract is about to expire, whether the manufacturer's warranty is about to expire or the number of times a consumer has previously been contacted. Once these preferences have been set by the service center, the email solicits may be delivered based on those preferences.

As suggested above, each email may contain the unique and personalized link created for the consumer to whom the email is being delivered so that the consumer may directly link to a Web application that will enable the consumer to review the terms and conditions of that consumer's warranty offer, make specific selections and permit the consumer to purchase the warranty services over the telecommunications medium 16. The link may be an activatable link in the form of an icon or other indicia that informs the consumer that direct access is being provided for the consumer to review and purchase that consumer's personalized warranty services over the telecommunications medium 16. Activating the link will cause the consumer's telecommunications device 18 to download an introductory Web page generated by the computer server system 10. The introductory Web page may be specifically tailored to the consumer associated with the unique and personalized link and may include text providing a brief overview of the terms of the extended warranty offer or other information as desired by the service center. In an alternate aspect of the present invention, if a consumer accesses the introductory Web page in a manner other than by clicking on the unique and personalize link, the consumer will be queried to enter that consumer's unique identifier before proceeding through the Web application described below.

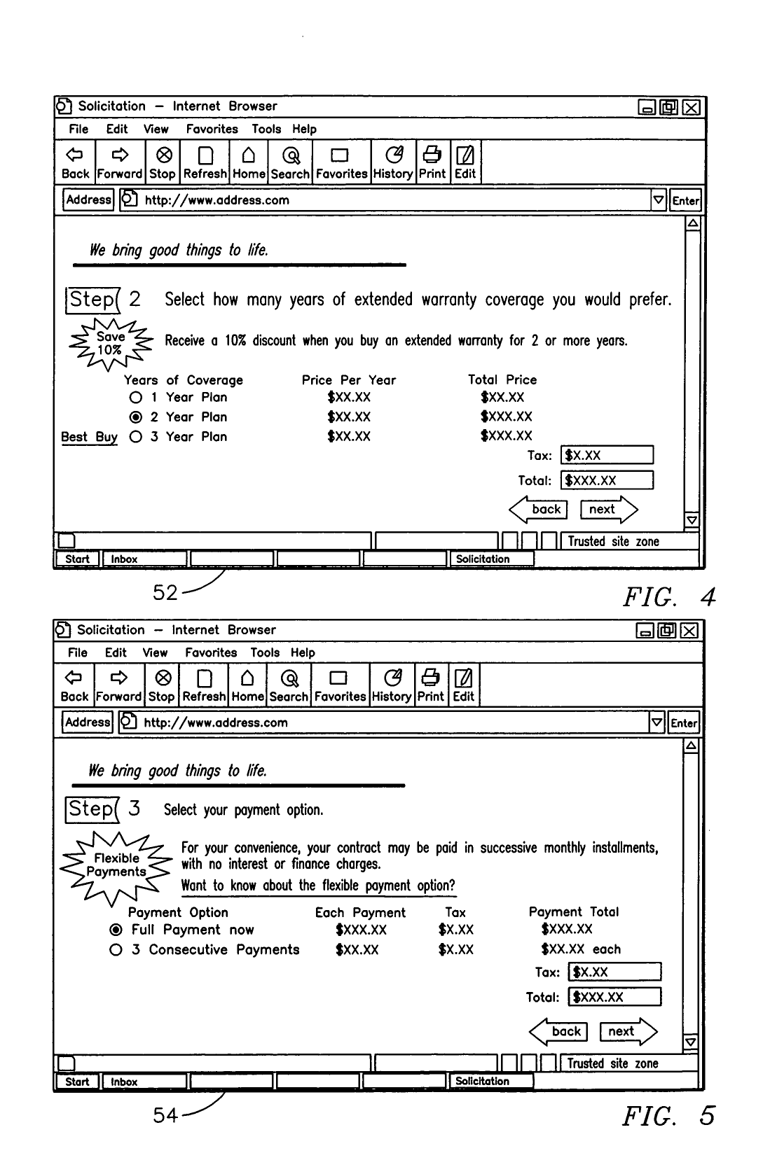

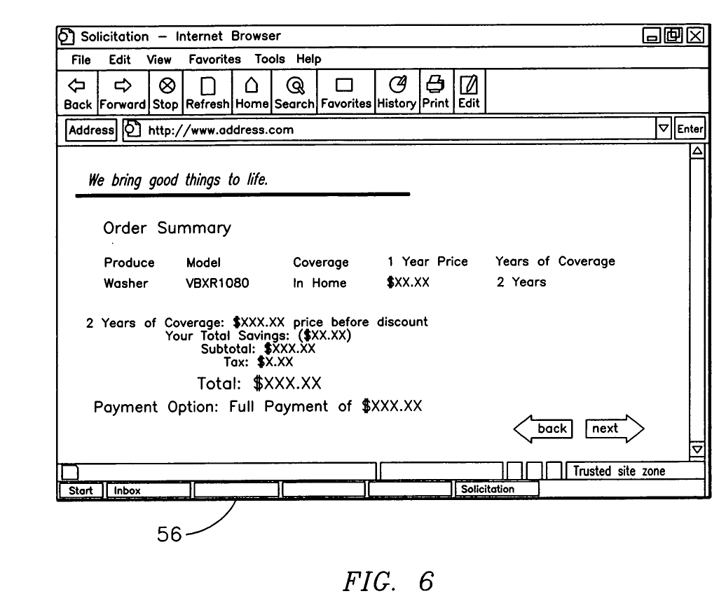

Subsequent to the introductory Web page, not shown, the consumer may be presented with additional Web pages linked from the introductory Web page. For example, FIG. 3 illustrates an exemplary Web page form 50, which enables the consumer to select each product that the consumer desires to be covered by the extended warranty. It should be understood that form 50 may list more than one product depending on how many products the consumer has purchased, when they were purchased, whether any are already covered by an extended warranty and whether the service center decides to include more than one product in a particular solicit. The form 50 provides details of the personalized offer made to that consumer, which are derived from the consumer data 22 and step 34 of FIG. 2A. Thus, there is no need for the consumer to reenter data contained in the consumer data 22 or enter any additional information before proceeding. FIG. 4 illustrates another exemplary Web page form 52, which enables the consumer to select in a clickable field the number of years that the consumer desires extended warranty coverage for the product(s) selected in form 50. Similarly, FIG. 5 illustrates another exemplary Web page form 54, which enables the consumer to select in a clickable field the payment option that the consumer desires. FIG. 6 illustrates another exemplary Web page form 56, which summarizes the selections made by the consumer for the consumer's review prior to making the purchase of the warranty services. Form 56 may provide a clickable link or icon, such as the one shown in FIG. 6 labeled “check out” so that the consumer can finalize the purchase of the warranty services after reviewing their selections.

Other Web based forms may be provided as part of the Web application by the service center as desired. In an alternate aspect of the present invention the initial form 50 may also include clickable fields or pull down menus that provide the consumer with the choices included in forms 52 and 54 thereby presenting these choices in one Web page form instead of three. Other aspects of the invention may provide Web pages enabling a consumer to purchase extended warranty services for products other than those contained in that consumer's solicit. Appropriate pull down menus, selectable fields or activatable links may be provided to enable the consumer to choose from a variety of extended warranty service options for such other products and purchase those options over the telecommunications medium 16.

Returning to FIG. 2B, another aspect of the computerized method of the present invention allows for actions taken by a consumer, or the consumer's failure to act, to be tracked so that the service center may determine the status of solicits and what follow up action must be taken, if any, and when. For example, it is not uncommon for consumers to change email addresses from time to time causing emails sent to a nonworking address to be returned to the sender as undeliverable. Step 60 allows for tracking whether such emails are successfully delivered. If emails are returned as undeliverable then step 61 allows for the service center to be notified, which may be configured to resolve whether that address is unusable. If it is an unusable address then the data file associated with that consumer may be flagged as such to prevent further electronic solicits from being sent to that address. Step 61 may allow for a paper solicit to be mailed. If an email is successfully delivered then step 62 allows for tracking whether a consumer opens that email with step 64 allowing for tracking whether the consumer clicks on the unique and personalized link thereby accessing that consumer's personalized warranty offer as described above. If the consumer does not open the email then step 61 allows for the service center to be notified and a paper solicit to be mailed. Similarly, if the consumer opens the email but does not activate the unique and personalized link then step 61 allows for the service center to be notified and a paper solicit to be mailed. After accessing the offer, step 66 allows for tracking whether the consumer purchases the offered warranty services contract. As shown in FIG. 2B, for all actions other than the consumer purchasing the extended warranty services, the letter shop 24 may mail a paper solicit to the consumer as a follow-up to the electronic solicit after the expiration of a predetermined period of time measured from the time the electronic solicit is first sent over the telecommunications medium 16. Alternatively, if a consumer does not respond within a certain period of time to either a paper or electronic solicit, a follow-up paper or electronic solicit may be delivered to that consumer. Also, step 68 allows for feedback to be provided to a marketing center to suppress further solicits in the event a consumer purchases the warranty services offered in a paper or electronic solicit.

The present invention can be embodied in the form of computer-implemented processes and apparatus for practicing those processes. The present invention can also be embodied in the form of computer program code containing computer-readable instructions embodied in tangible media, such as floppy diskettes, CD-ROMs, hard drives or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cable, through fiber optics, or via electromagnetic radiation, wherein, when the computer program code is loaded into and executed by a computer, the computer becomes an apparatus for practicing the invention. When implemented on a general-purpose computer, the computer program code segments configure the computer to create logic specific circuits or processing modules.

It will be understood that the specific embodiment of the invention shown and described herein is exemplary only. Numerous variations, changes, substitutions and equivalents will now occur to those skilled in the art without departing from the spirit and scope of the present invention. Accordingly, it is intended that all subject matter described herein and shown in the accompanying drawings be regarded as illustrative only and not in a limiting sense and that the scope of the invention be solely determined by the appended claims.

1. A computerized method for use over a telecommunications medium for enabling the offer and purchase of extended warranty services associated with a product, the method comprising:
storing data in a database associated with a consumer purchasing a product, the data including consumer-specific information and product-specific information associating the consumer with the purchased product;
generating an extended warranty service offer for the purchased product;
storing an electronic file containing terms of the extended warranty service offer;
associating the electronic file containing terms of the extended warranty service offer with the stored consumer-specific data;
creating a unique identifier for the electronic file containing terms of the extended warranty service offer;
creating a unique and personalized link for the consumer to access the electronic file containing terms of the extended warranty service offer over the telecommunications medium;
operably embedding the unique identifier within the unique and personalize link so that when the consumer activates the link from a remote telecommunications device a Web page will be downloaded to the remote telecommunications device for accessing a Web application configured for reviewing and executing the purchase of the consumer's extended warranty service offer for the product;
generating an email containing the unique and personalized link; and
transmitting the email over the telecommunications medium to a remote telecommunications device for receipt by the consumer.

2. The computerized method of claim 1 further comprising:
storing data in the database indicating preferences associated with the consumer and the product; and
prioritizing the delivery of the email to the consumer over the telecommunications medium based on the set of preferences.

3. The computerized method of claim 2, the data indicating preferences including at least one of a date the product was purchased, an expiration date of an existing extended warranty contract for the product, a date the manufacturer's warranty will expire on the product and the number of times the consumer has been contacted previously with respect to purchasing the extended warranty service offer for the product.

4. The computerized method of claim 1 further comprising:
storing data in the database associated with a plurality of consumers each purchasing at least one product, the data including consumer-specific information and product-specific information associating each of the plurality of consumers with a respective product purchased by that consumer;
storing consumer preference data in the database for each consumer purchasing a product, the consumer preference data indicating the manner by which a consumer prefers to receive communications from a service center;
sorting the consumer-specific data stored in the database based on a consumer's preference data;
creating a first electronic file containing a first subset of consumer-specific data for those consumers who prefer to receive communications from the service center over the telecommunications medium;
creating a second electronic file containing a second subset of consumer-specific data for those consumers who prefer to receive communications from the service center through a paper mail service; and
storing the first and second electronic files in a database accessible by a live call-taking function of the service center.

5. The computerized method of claim 4 further comprising:
generating an extended warranty service offer for each product purchased by the plurality of consumers; and
associating an extended warranty service offer for a product with each of the plurality of consumers who purchased the product.

6. The computerized method of claim 5 further comprising:
retrieving data from the second electronic file containing the second subset of consumer-specific data;
determining which consumers from the second subset of consumer-specific data have an extended warranty service offer associated with them; and
generating a paper solicit containing terms of an extended warranty service offer for each consumer determined to have an extended warranty service offer associated with them.

7. The computerized method of claim 1 further comprising:
storing data in the database associated with a plurality of consumers each purchasing at least one product, the data including consumer-specific information and product-specific information associating each of the plurality of consumers with a respective product purchased by that consumer;
selecting a first subset of consumer-specific data based on a consumer preference;
generating an extended warranty service offer for a product purchased by at least one consumer selected from the consumer-specific data; and
delivering terms of the extended warranty service offer to the at least one consumer based on the consumer preference.

8. The computerized method of claim 1 further comprising:
downloading a Web page form from a server over the telecommunications medium to the remote telecommunications device when the unique and personalized link is activated;
enabling assess to the electronic file containing terms of the extended warranty service offer; and
presenting the terms of the extended warranty service offer within the Web page form, the Web page form including consumer-specific and product-specific data associated with the extended warranty service offer so that the consumer may purchase the extended warranty service offer without entering additional consumer-specific and product-specific data.

9. The computerized method of claim 8 further comprising:
enabling the Web page form so the consumer may select a number of years for which the extended warranty service offer will cover; and
enabling the Web page form so the consumer may select payment options for purchasing the extended warranty service offer.

10. A computerized method for use over a telecommunications medium enabling a consumer to purchase an extended warranty service offer with respect to a product purchased by the consumer, the method comprising:
storing consumer-specific information and product-specific information with respect to customers purchasing of products;
generating an extended warranty services offer with respect to a product purchased by at least one consumer;
storing the extended warranty services offer;
associating the extended warranty services offer with each consumer that purchased the product for which the extended warranty services offer was generated;
creating a unique and personalized link for each consumer that purchased the product, each unique and personalized link operable to download a Web page form over the telecommunications medium when activated;
embedding the unique and personalize link in an email;
transmitting the email over the telecommunications medium to an email address of at least one consumer that purchased the product; and
enabling the Web page form to be downloaded over the telecommunications medium from a server to a remote telecommunications device, the Web page form including selectable fields indicative of the extended warranty services and enabled for the at least one consumer to purchase the extended warranty services over the telecommunications medium.

11. The computerized method of claim 10 further comprising:
storing a set of consumer preferences for at least one consumer that purchased a product;
sorting the consumer-specific information based on the set of consumer preferences; and
determining a method of delivering the extended warranty services offer to the at least one consumer based on the set of consumer preferences.

12. The computerized method of claim 11, the set of consumer preferences comprising at least one of a preference for receiving communications over the telecommunications medium and a preference for receiving communications via a paper mail service.

13. The computerized method of claim 10 further comprising:
determining whether the email is successfully received by the email address of the at least one consumer; and
mailing a paper solicit containing the extended warranty services offer to the at least one consumer if the email is not successfully received by the email address of the at least one consumer.

14. The computerized method of claim 10, further comprising:
mailing a paper solicit containing the extended warranty services offer to the at least one consumer if the email is successfully received by the email address of the at least one consumer and the at least one consumer has not purchased the extended warranty services offer within a predetermined period of time.

15. The computerized method of claim 10, further comprising:
storing a set of consumer preferences for at least one consumer that purchased a product;
sorting at least the consumer-specific information based on the set of consumer preferences;
storing a first subset of the sorted consumer-specific data;
storing a second subset of the sorted consumer-specific data;
transmitting the email over the telecommunications medium to an email address of at least one consumer selected from the first subset of the sorted consumer-specific data; and
mailing a paper solicit containing the extended warranty services offer to at least one consumer selected from the second subset of the sorted consumer-specific data.

16. The computerized method of claim 10 further comprising:
including in the Web page form selectable fields indicative of extended warranty service offers for at least one product previously purchased by the at least one consumer and enabled for the at least one consumer to purchase over the telecommunications medium.
